(19) United States
(12) Patent Application Publication
(10) Pub. No.: US 2026/0159078 A1
(43) Pub. Date: Jun. 11, 2026

(54) APPARATUS AND METHOD FOR CONTROLLING A VEHICLE, COMPUTER-READABLE STORAGE MEDIUM

(71) Applicant: HL Klemove Corp., Incheon (KR)

(72) Inventor: Donghyeon KIM, Incheon (KR)

(73) Assignee: HL Klemove Corp., Incheon (KR)

(21) Appl. No.: 19/410,289

(22) Filed: Dec. 5, 2025

(30) Foreign Application Priority Data
Dec. 5, 2024 (KR) 10-2024-0179914

(51) Int. Cl. B60W 30/09; B60W 10/20; B60W 30/095; B60W 50/00

(52) U.S. Cl. CPC B60W 30/09; B60W 10/20; B60W 30/0956; B60W 50/00; B60W 2050/0031; B60W 2540/18; B60W 2554/80

(57) ABSTRACT

An apparatus and method for controlling a vehicle, and a non-transitory computer-readable storage medium storing a program for performing the method, are disclosed. A vehicle control apparatus according to an aspect of the present disclosure may include at least one sensor mounted to a vehicle and configured to detect a target existing around the vehicle, and a controller configured to determine a position of the target based on detection information of the at least one sensor, determine a turning radius of the target according to a preset initial avoidance steering angle, and control the vehicle to be steered according to an avoidance steering angle for avoiding the target when the turning radius of the target is equal to or less than a reference distance.

### CROSS-REFERENCE TO RELATED APPLICATION

This application claims priority to and benefit from Korean Patent Application No. 10-2024-0179914, filed on Dec. 5, 2024, the disclosure of which is incorporated herein by reference in its entirety.

### TECHNICAL FIELD

The present disclosure relates to an apparatus and a method for controlling a vehicle, and more particularly, to an apparatus and a method for performing steering control to avoid a collision between a vehicle and an obstacle during driving of the vehicle.

### RELATED ART

In recent years, various advanced driver assistance systems (ADAS) have been developed to enhance driver convenience in connection with vehicle operation. In addition, vehicles equipped with a remote forward/reverse driving function, which allows a vehicle to be moved forward or backward remotely without a driver on board, have also been introduced.

When driving assistance by an advanced driver assistance system or remote forward/reverse driving of a vehicle is performed, ensuring safety is required. To this end, there is a need for developing technology capable of effectively preventing a collision between a vehicle and surrounding objects even without driver intervention.

### SUMMARY

The present disclosure has been made to address the above-described issues, and an object of the present disclosure is to provide an apparatus and a method for controlling a vehicle that prevent a collision between a vehicle and an object around the vehicle without driver intervention during driving of the vehicle.

Another object of the present disclosure is to provide an apparatus and a method for controlling a vehicle that prevent a collision between a vehicle and an object around the vehicle during remote driving of the vehicle.

The objects of the present disclosure are not limited to the above-described objects, and other objects that are not mentioned will be able to be clearly understood by those skilled in the art to which the present disclosure pertains from the following description.

According to an exemplary embodiment of the present disclosure, provided is a vehicle control apparatus, comprising at least one sensor mounted to a vehicle and configured to detect a target existing around the vehicle; and a controller configured to determine a position of the target based on detection information of the at least one sensor, determine a turning radius of the target according to a preset initial avoidance steering angle, and control the vehicle to be steered according to an avoidance steering angle for avoiding the target when the turning radius of the target is equal to or less than a reference distance.

In the vehicle control apparatus according to an aspect of the present disclosure, the controller may be configured to determine the position of the target as coordinates on a two-dimensional plane in which a rear-wheel center of the vehicle, which is an intermediate point between a left rear wheel and a right rear wheel of the vehicle, serves as an origin, and axes parallel to a longitudinal direction of the vehicle and a lateral direction of the vehicle serve as two coordinate axes.

In the vehicle control apparatus according to an aspect of the present disclosure, the controller may be configured to determine the turning radius of the target according to Equation 1:

$${R}_{obj} = \sqrt{{( R + Y 1 )}^{2} + X {1}^{2}} \qquad ( Equation 1 )$$

(R_{obj}: turning radius of the target, R: turning radius of a rear-wheel center of the vehicle, X1: coordinate value among the coordinates that is parallel to a longitudinal direction of the vehicle, Y1: coordinate value among the coordinates that is parallel to a lateral direction of the vehicle)

In the vehicle control apparatus according to an aspect of the present disclosure, a turning radius of a rear-wheel center of the vehicle according to the initial avoidance steering angle may be determined as expressed in Equation 2:

$$R = \frac{B}{{tan}_{a}} \qquad ( Equation 2 )$$

(R: turning radius of a rear-wheel center of the vehicle, B: wheelbase of the vehicle, α: the initial avoidance steering angle)

In the vehicle control apparatus according to an aspect of the present disclosure, the reference distance may be set as a sum of an outer turning radius of the vehicle and a margin distance.

In the vehicle control apparatus according to an aspect of the present disclosure, an outer turning radius of the vehicle may be determined as expressed in Equation 3:

$${R}_{car} = \sqrt{{( R + \frac{W}{2} )}^{2} + {( L - H )}^{2}} \qquad ( Equation 3 )$$

(R_{car}: outer turning radius of the vehicle, R: turning radius of a rear-wheel center of the vehicle, W: vehicle width, L: vehicle length, H: rear overhang of the vehicle)

In the vehicle control apparatus according to an aspect of the present disclosure, the controller may be configured to control the vehicle to maintain an existing steering angle when the turning radius of the target exceeds the reference distance.

In the vehicle control apparatus according to an aspect of the present disclosure, the controller may be configured to control the vehicle to be steered according to the initial avoidance steering angle when the turning radius of the target is equal to or less than the reference distance.

In the vehicle control apparatus according to an aspect of the present disclosure, the controller may be configured to, after controlling the vehicle according to the initial avoidance steering angle, additionally determine whether the turning radius of the target is equal to or less than the reference distance, and control the vehicle to be steered with an increased steering angle compared to the initial avoidance steering angle when the turning radius of the target is equal to or less than the reference distance.

In the vehicle control apparatus according to an aspect of the present disclosure, the controller may be configured to, after controlling the vehicle according to the initial avoidance steering angle, additionally determine whether the turning radius of the target is equal to or less than the reference distance, and control the vehicle to be steered with a reduced steering angle compared to the initial avoidance steering angle when the turning radius of the target exceeds the reference distance.

According to another aspect of the present disclosure, provided is a vehicle control method, comprising determining, by a controller, a position of a target existing around a vehicle based on detection information of at least one sensor mounted to the vehicle; determining, by the controller, a turning radius of the target according to a preset initial avoidance steering angle; determining, by the controller, whether the turning radius of the target is equal to or less than a reference distance; and controlling, by the controller, the vehicle to be steered according to an avoidance steering angle for avoiding the target when the turning radius of the target is equal to or less than the reference distance.

In the vehicle control method according to an aspect of the present disclosure, determining the position of the target may include determining, by the controller, the position of the target as coordinates on a two-dimensional plane in which a rear-wheel center of the vehicle, which is an intermediate point between a left rear wheel and a right rear wheel of the vehicle, serves as an origin, and axes parallel to a longitudinal direction of the vehicle and a lateral direction of the vehicle serve as two coordinate axes.

In the vehicle control method according to an aspect of the present disclosure, determining the turning radius of the target may include determining, by the controller, the turning radius of the target according to Equation 1:

$${R}_{obj} = \sqrt{{( R + Y 1 )}^{2} + X {1}^{2}} \qquad ( Equation 1 )$$

(R_{obj}: turning radius of the target, R: turning radius of a rear-wheel center of the vehicle, X1: coordinate value among the coordinates that is parallel to a longitudinal direction of the vehicle, Y1: coordinate value among the coordinates that is parallel to a lateral direction of the vehicle)

In the vehicle control method according to an aspect of the present disclosure, determining a turning radius of a rear-wheel center of the vehicle according to the initial avoidance steering angle may include determining the turning radius of the rear-wheel center of the vehicle as expressed in Equation 2:

$$R = \frac{B}{{tan}_{a}} \qquad ( Equation 2 )$$

(R: turning radius of a rear-wheel center of the vehicle, B: wheelbase of the vehicle, α: the initial avoidance steering angle)

In the vehicle control method according to an aspect of the present disclosure, the reference distance may be set as a sum of an outer turning radius of the vehicle and a margin distance.

In the vehicle control method according to an aspect of the present disclosure, determining the outer turning radius of the vehicle may include determining the outer turning radius of the vehicle as expressed in Equation 3:

$${R}_{car} = \sqrt{{( R + \frac{W}{2} )}^{2} + {( L - H )}^{2}} \qquad ( Equation 3 )$$

(R_{car}: outer turning radius of the vehicle, R: turning radius of a rear-wheel center of the vehicle, W: vehicle width, L: vehicle length, H: rear overhang of the vehicle)

In the vehicle control method according to an aspect of the present disclosure, controlling the vehicle to be steered according to the avoidance steering angle may include controlling, by the controller, the vehicle to be steered according to the initial avoidance steering angle.

In the vehicle control method according to an aspect of the present disclosure, controlling the vehicle to be steered according to the avoidance steering angle may further include determining, by the controller, whether the turning radius of the target is equal to or less than the reference distance.

In the vehicle control method according to an aspect of the present disclosure, controlling the vehicle to be steered according to the avoidance steering angle may further include controlling, by the controller, the vehicle to be steered with an increased steering angle relative to the initial avoidance steering angle when the turning radius of the target is equal to or less than the reference distance.

In the vehicle control method according to an aspect of the present disclosure, controlling the vehicle to be steered according to the avoidance steering angle may further include controlling, by the controller, the vehicle to be steered with a decreased steering angle relative to the initial avoidance steering angle when the turning radius of the target exceeds the reference distance.

According to another aspect of the present disclosure, provided is a non-transitory computer-readable storage medium storing a program comprising at least one instruction for performing a vehicle control method, the vehicle control method comprising determining, by a controller, a position of a target existing around a vehicle based on detection information of at least one sensor mounted to the vehicle; determining, by the controller, a turning radius of the target according to a preset initial avoidance steering angle; determining, by the controller, whether the turning radius of the target is equal to or less than a reference distance; and controlling, by the controller, the vehicle to be steered according to an avoidance steering angle for avoiding the target when the turning radius of the target is equal to or less than the reference distance.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a configuration of a vehicle control apparatus according to an exemplary embodiment of the present disclosure.

FIG. 2 is a diagram illustrating determination of a position of a target around a vehicle by a vehicle control apparatus according to an exemplary embodiment of the present disclosure.

FIG. 3 is a diagram illustrating a turning radius of a rear-wheel center of a vehicle used in a vehicle control apparatus according to an exemplary embodiment of the present disclosure.

FIG. 4 is a diagram illustrating an outer turning radius of a vehicle used in a vehicle control apparatus according to an exemplary embodiment of the present disclosure.

FIG. 5 is a diagram illustrating determination of a turning radius of a target by a vehicle control apparatus according to an exemplary embodiment of the present disclosure.

FIG. 6 is a diagram illustrating a case in which the turning radius of the target is smaller than a reference distance.

FIG. 7 is a diagram illustrating a case in which the turning radius of the target is greater than a reference distance.

FIG. 8 is a flowchart of a vehicle control method according to an exemplary embodiment of the present disclosure.

FIG. 9 is a detailed flowchart of a step of controlling a vehicle to be steered according to an avoidance steering angle in a vehicle control method according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

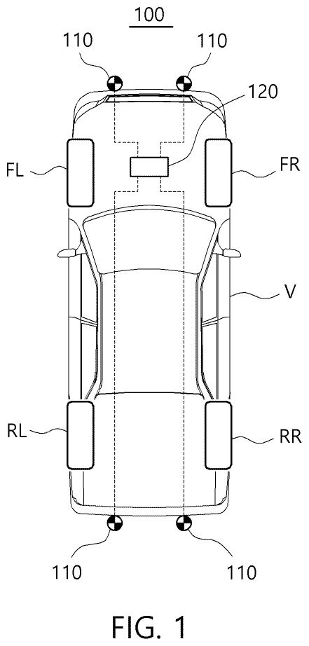

FIG. 1 is a diagram illustrating a configuration of a vehicle control apparatus according to an exemplary embodiment of the present disclosure.

A vehicle control apparatus 100 according to an exemplary embodiment of the present disclosure prevents a collision between a vehicle V and a surrounding object during driving of the vehicle V. For example, the vehicle control apparatus 100 may steer the vehicle V so that the vehicle V does not collide with a surrounding object when the vehicle V is remotely driven forward or backward without a driver on board.

The vehicle control apparatus 100 according to an exemplary embodiment of the present disclosure may be mounted to a vehicle V. In this case, the vehicle V may include four wheels, that is, a left front wheel FL, a right front wheel FR, a left rear wheel RL, and a right rear wheel RR.

Referring to FIG. 1, the vehicle control apparatus 100 according to an exemplary embodiment of the present disclosure may include at least one sensor 110 and a controller 120.

The at least one sensor 110 is mounted to the vehicle V and detects a target existing around the vehicle V. For example, the at least one sensor 110 may include an ultrasonic sensor. In addition, the at least one sensor 110 may further include at least one of an image sensor, a radar sensor, or a Lidar sensor.

The controller 120 determines a position of the target based on detection information of the sensor 110. Here, the target may be another vehicle, a pedestrian, another structure, or the like. The target may be in a stationary state. In addition, the target may also be in motion.

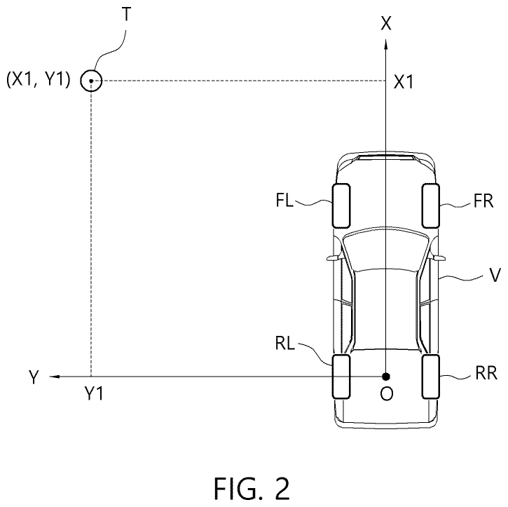

FIG. 2 is a diagram illustrating determination of a position of a target around a vehicle by a vehicle control apparatus according to an exemplary embodiment of the present disclosure.

Referring to FIG. 2, the controller 120 may determine a position of the target T as coordinates on a two-dimensional plane in which a rear-wheel center O of the vehicle V, which is an intermediate point between a left rear wheel RL and a right rear wheel RR of the vehicle V, serves as an origin, and axes parallel to a longitudinal direction of the vehicle V and a lateral direction of the vehicle V serve as two coordinate axes. More specifically, an axis parallel to the longitudinal direction of the vehicle V may be set as an X-axis, and an axis parallel to the lateral direction of the vehicle V may be set as a Y-axis.

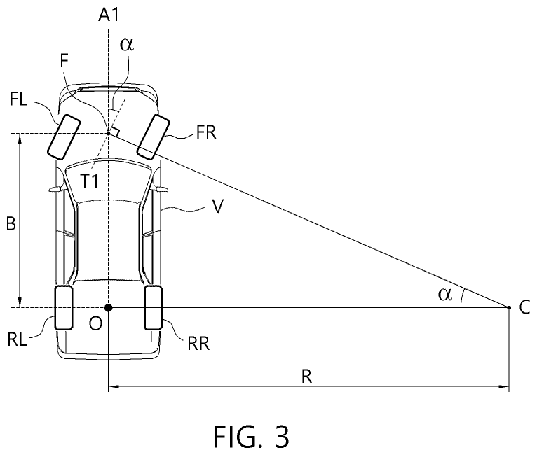

FIG. 3 is a diagram illustrating a turning radius of a rear-wheel center of a vehicle used in a vehicle control apparatus according to an exemplary embodiment of the present disclosure.

A turning radius R of the rear-wheel center of the vehicle is used in determining an outer turning radius of the vehicle and a turning radius of a target, which will be described later. The turning radius R of the rear-wheel center of the vehicle is determined according to a preset initial avoidance steering angle α.

The initial avoidance steering angle α may be defined as an initial steering value used when steering to avoid a collision with the target T. For example, the initial avoidance steering angle α may be set to one half of a maximum steering angle of the vehicle V.

In this case, the initial avoidance steering angle α may be set in a right-turn direction or a left-turn direction of the vehicle V. In other words, when the target T is located on a left side of the vehicle V, avoidance steering may be performed according to the initial avoidance steering angle α set in the right-turn direction, and when the target T is located on a right side of the vehicle V, avoidance steering may be performed according to the initial avoidance steering angle α set in the left-turn direction.

The controller 120 may store a preset initial avoidance steering angle α and a turning radius R of the rear-wheel center of the vehicle corresponding thereto. In other words, the controller 120 may store, in advance, an initial avoidance steering angle α that is set and a turning radius R of the rear-wheel center of the vehicle corresponding thereto.

Referring to FIG. 3, when a midpoint between the left front wheel FL and the right front wheel FR of the vehicle V is defined as a front-wheel center F of the vehicle, a steering angle of the vehicle corresponds to an angle formed between a longitudinal axis A1 of the vehicle, which passes through the rear-wheel center O and the front-wheel center F of the vehicle, and the left front wheel FL or the right front wheel FR of the vehicle. Accordingly, a turning radius R of the rear-wheel center of the vehicle according to the initial avoidance steering angle α may be determined as expressed in (Equation 2).

$$R = \frac{B}{{tan}_{a}} \qquad ( Equation 2 )$$

(R: turning radius of rear-wheel center of vehicle, B: wheelbase of vehicle, α: initial avoidance steering angle)

Meanwhile, a turning center C of the rear-wheel center of the vehicle may be defined as a center of a circle (or circular arc) formed along a path of the rear-wheel center O of the vehicle V when the vehicle V travels according to the initial avoidance steering angle α.

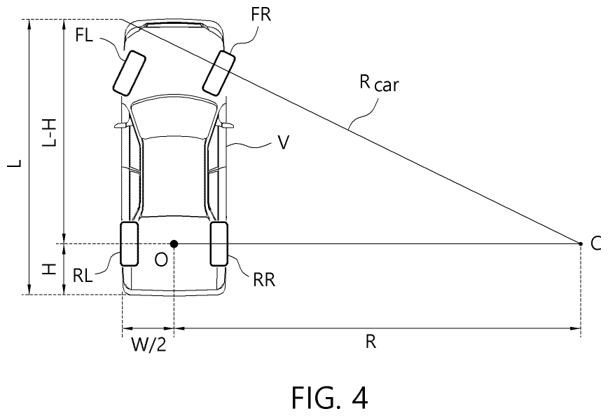

FIG. 4 is a diagram illustrating an outer turning radius of a vehicle used in a vehicle control apparatus according to an exemplary embodiment of the present disclosure.

An outer turning radius R_{car} of the vehicle may be used as a comparison reference for determining a possibility of collision between the vehicle V and the target T. More specifically, the outer turning radius R_{car} of the vehicle may serve as a component that constitutes a reference distance for determining a possibility of collision between the vehicle V and the target T.

Referring to FIG. 4, an outer turning radius R_{car} of the vehicle may be determined as expressed in (Equation 3).

$${R}_{car} = \sqrt{{( R + \frac{W}{2} )}^{2} + {( L - H )}^{2}} \qquad ( Equation 3 )$$

(R_{car}: outer turning radius of vehicle, R: turning radius of rear-wheel center of vehicle, W: vehicle width, L: vehicle length, H: rear overhang of vehicle)

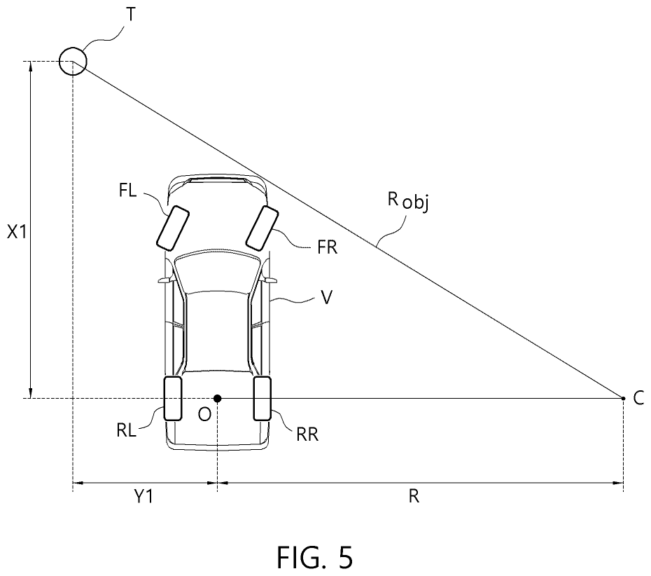

FIG. 5 is a diagram illustrating determination of a turning radius of a target by a vehicle control apparatus according to an exemplary embodiment of the present disclosure.

A turning radius R_{obj} of the target may be used as a variable for determining a possibility of collision between the vehicle V and the target T. More specifically, the turning radius R_{obj} of the target may serve as a variable to be compared with the reference distance, which includes the outer turning radius R_{car} of the vehicle as one component.

Referring to FIG. 5, the controller 120 may determine a turning radius R_{obj} of the target according to (Equation 1).

$${R}_{obj} = \sqrt{{( R + Y 1 )}^{2} + X {1}^{2}} \qquad ( Equation 1 )$$

(R_{obj}: turning radius of target, R: turning radius of rear-wheel center of vehicle, X1: X-coordinate value of target position, Y1: Y-coordinate value of target position)

The controller 120 determines a turning radius R_{obj} of the target according to the preset initial avoidance steering angle α, and controls the vehicle V to be steered according to an avoidance steering angle for avoiding the target T when the turning radius R_{obj} of the target is equal to or less than the reference distance.

In this case, the reference distance may be set as a sum of the outer turning radius R_{car} of the vehicle and a margin distance. The margin distance may be predetermined in consideration of factors such as a size of the vehicle V.

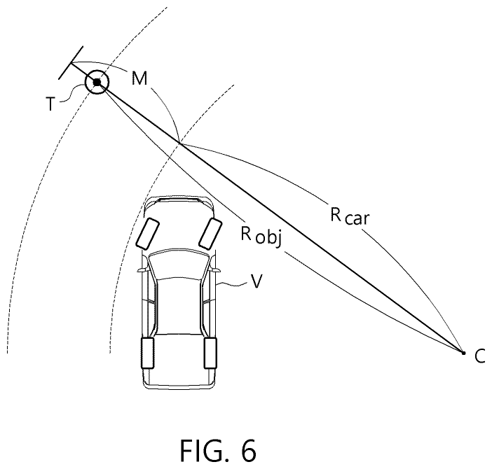

FIG. 6 is a diagram illustrating a case in which the turning radius of the target is smaller than a reference distance.

Referring to FIG. 6, the turning radius R_{obj} of the target appears to be smaller than a sum of the outer turning radius R_{car} of the vehicle and a margin distance M. Here, the reference distance is the sum of the outer turning radius R_{car} of the vehicle and the margin distance M.

When the turning radius R_{obj} of the target is the same as the outer turning radius R_{car} of the vehicle, the vehicle V may collide with the target T while moving forward or backward. The margin distance M may be set as a distance that allows such a collision to be avoided. When the turning radius R_{obj} of the target is equal to or less than the reference distance, it may be regarded that the margin distance M is not secured between the vehicle V and the target T.

As described above, the controller 120 may determine a turning radius R_{obj} of the target T based on a turning radius R of the rear-wheel center of the vehicle and a position of the target T represented as two-dimensional coordinates. In addition, the outer turning radius R_{car} of the vehicle, which is determined based on the turning radius R of the rear-wheel center of the vehicle, a vehicle length L of the vehicle V, and a rear overhang H of the vehicle V, may be stored in advance in the controller 120.

As shown in FIG. 6, when the turning radius R_{obj} of the target is equal to or less than the reference distance, the controller 120 controls the vehicle V to be steered according to an avoidance steering angle for avoiding the target T. More specifically, the controller 120 may control the vehicle V to be steered according to the initial avoidance steering angle α.

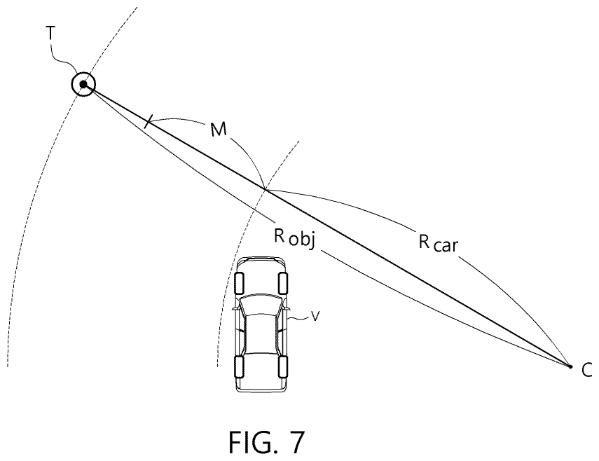

FIG. 7 is a diagram illustrating a case in which the turning radius of the target is greater than a reference distance.

Referring to FIG. 7, the turning radius R_{obj} of the target appears to be greater than a sum of the outer turning radius Rear of the vehicle and a margin distance M. As described above, the reference distance refers to the sum of the outer turning radius R_{car} of the vehicle and the margin distance M. When the turning radius R_{obj} of the target exceeds the reference distance, it may be regarded that the margin distance M is secured between the vehicle V and the target T.

As shown in FIG. 7, when the turning radius R_{obj} of the target exceeds the reference distance, the controller 120 may control the vehicle V to maintain an existing steering angle. For example, when the vehicle V has been moving forward or backward, the controller 120 may set a steering angle of the vehicle V to zero and perform steering control so that the vehicle V continues to move forward or backward.

Meanwhile, in an exemplary embodiment of the present disclosure, after controlling the vehicle V according to the initial avoidance steering angle α, the controller 120 may additionally determine whether the turning radius R_{obj} of the target is equal to or less than the reference distance.

Even when steering control is performed according to the initial avoidance steering angle α, if the turning radius R_{obj} of the target is still equal to or less than the reference distance, this indicates that steering control based on the initial avoidance steering angle α is not sufficient to avoid a collision with the target T. Accordingly, when it is additionally determined that the turning radius R_{obj} of the target is equal to or less than the reference distance, the controller 120 may control the vehicle V to be steered with an increased steering angle compared to the initial avoidance steering angle α. For example, the controller 120 may increase the steering angle by 50% compared to the initial avoidance steering angle α.

If, after steering control according to the initial avoidance steering angle α, the turning radius R_{obj} of the target is found to exceed the reference distance, this indicates that the steering control based on the initial avoidance steering angle α was sufficient to avoid a collision with the target T. Accordingly, when it is additionally determined that the turning radius R_{obj} of the target exceeds the reference distance, the controller 120 may control the vehicle V to be steered with a reduced steering angle compared to the initial avoidance steering angle α. For example, the controller 120 may decrease the steering angle by 50% compared to the initial avoidance steering angle α.

In this manner, the controller 120 controls the vehicle V to be steered according to an avoidance steering angle for avoiding the target T, and, after controlling the vehicle V according to the initial avoidance steering angle α, additionally determines whether the turning radius R_{obj} of the target is equal to or less than the reference distance and continuously adjusts the steering angle based on the additional determination result, thereby enabling a collision to be avoided even when the target T is in motion by reflecting the position of the target T in real time.

Meanwhile, when the turning radius R_{obj} of the target is equal to or less than the reference distance such that there is a risk of collision between the vehicle V and the target T, the controller 120 may also brake the vehicle V. In this regard, the controller 120 may store a collision-risk distance set to be smaller than the reference distance.

For example, when the turning radius R_{obj} of the target is found to be smaller than the collision-risk distance despite steering control according to the initial avoidance steering angle α, the controller 120 may automatically perform braking control on the vehicle V.

The controller 120 may be implemented as an MCU (Micro Controller Unit) or an ECU (Electronic Control Unit) installed in the vehicle V. The controller 120 may include at least one arithmetic logic unit (ALU) and processing registers. In addition, the controller 120 may include a memory for storing data.

As described above, the vehicle control apparatus 100 according to an exemplary embodiment of the present disclosure has been described. Hereinafter, a vehicle control method according to an exemplary embodiment of the present disclosure will be described.

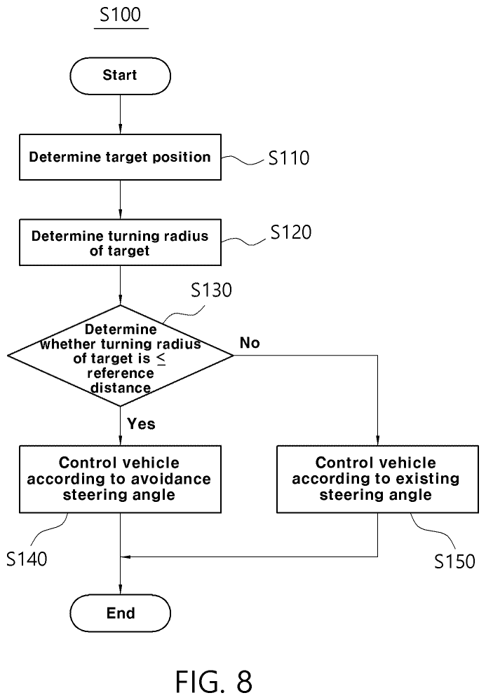

FIG. 8 is a flowchart of a vehicle control method according to an exemplary embodiment of the present disclosure.

A vehicle control method S100 according to an exemplary embodiment of the present disclosure prevents a collision with a surrounding object during driving of the vehicle V. For example, the vehicle control method S100 may be performed such that the vehicle V does not collide with a surrounding object when the vehicle Vis remotely driven forward or backward without a driver on board. The vehicle control method S100 may be performed by the vehicle control apparatus 100 described above.

Referring to FIG. 8, a vehicle control method S100 according to an exemplary embodiment of the present disclosure may be performed as follows.

First, the controller 120 determines a position of a target T existing around the vehicle V based on detection information of at least one sensor 110 mounted to the vehicle V (S110).

The target may be another vehicle, a pedestrian, another structure, or the like. The target T may be stationary or may be in motion.

More specifically, the controller 120 may determine a position of the target T as coordinates on a two-dimensional plane in which a rear-wheel center O of the vehicle V, which is an intermediate point between a left rear wheel RL and a right rear wheel RR of the vehicle V, serves as an origin, and axes parallel to a longitudinal direction of the vehicle V and a lateral direction of the vehicle V serve as two coordinate axes. For example, an axis parallel to the longitudinal direction of the vehicle V may be set as an X-axis, and an axis parallel to the lateral direction of the vehicle V may be set as a Y-axis.

Next, the controller 120 determines a turning radius R_{obj} of the target according to a preset initial avoidance steering angle α (S120).

A turning radius R_{obj} of the target may be used as a variable for determining a possibility of collision between the vehicle V and the target T. More specifically, the turning radius R_{obj} of the target may serve as a variable to be compared with the reference distance, which includes the outer turning radius R_{car} of the vehicle as a component.

As described above, the controller 120 may determine a turning radius R_{obj} of the target according to (Equation 1).

$${R}_{obj} = \sqrt{{( R + Y 1 )}^{2} + X {1}^{2}} \qquad ( Equation 1 )$$

(R_{obj}: turning radius of target, R: turning radius of rear-wheel center of vehicle, X1: X-coordinate value of target position, Y1: Y-coordinate value of target position)

In this regard, a turning radius R of the rear-wheel center of the vehicle according to the initial avoidance steering angle α may be determined as expressed in (Equation 2).

$$R = \frac{B}{{tan}_{a}} \qquad ( Equation 2 )$$

(R: turning radius of rear-wheel center of vehicle, B: wheelbase of vehicle, α: initial avoidance steering angle)

Meanwhile, an outer turning radius R_{car} of the vehicle, which serves as one component of the reference distance, may be determined as expressed in (Equation 3).

$${R}_{car} = \sqrt{{( R + \frac{W}{2} )}^{2} + {( L - H )}^{2}} \qquad ( Equation 3 )$$

(R_{car}: outer turning radius of vehicle, R: turning radius of rear-wheel center of vehicle, W: vehicle width, L: vehicle length, H: rear overhang of vehicle)

Next, the controller 120 determines whether the turning radius R_{obj} of the target is equal to or less than the reference distance (S130).

As described above, the reference distance may be set as a sum of the outer turning radius R_{car} of the vehicle and a margin distance M.

When the turning radius R_{obj} of the target is equal to or less than the reference distance, it may be regarded that the margin distance M is not secured between the vehicle V and the target T. Meanwhile, when the turning radius R_{obj} of the target exceeds the reference distance, it may be regarded that the margin distance M is secured between the vehicle V and the target T.

Next, when the turning radius R_{obj} of the target is equal to or less than the reference distance, the controller 120 controls the vehicle V to be steered according to an avoidance steering angle for avoiding the target T (S140).

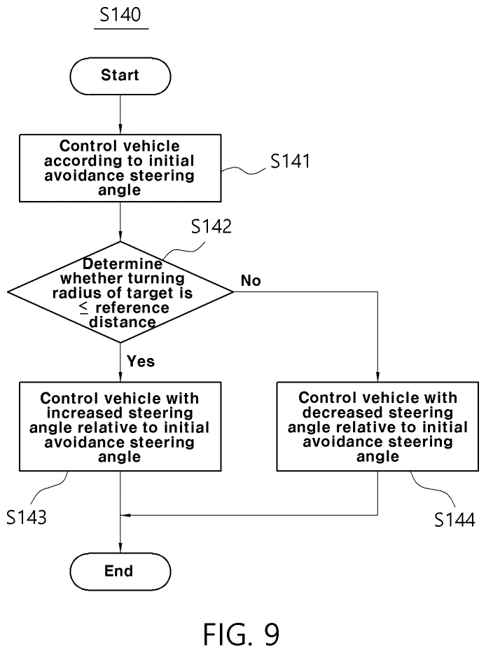

FIG. 9 is a detailed flowchart of a step of controlling a vehicle to be steered according to an avoidance steering angle in a vehicle control method according to an exemplary embodiment of the present disclosure.

Referring to FIG. 9, a step S140 of controlling the vehicle V to be steered according to an avoidance steering angle may be performed as follows.

First, the controller 120 controls the vehicle V to be steered according to the initial avoidance steering angle α (S141).

Next, the controller 120 additionally determines whether the turning radius R_{obj} of the target is equal to or less than the reference distance (S142). That is, after controlling the vehicle V according to the initial avoidance steering angle α, the controller 120 may additionally determine whether the turning radius R_{obj} of the target is equal to or less than the reference distance.

Next, when it is additionally determined that the turning radius R_{obj} of the target is equal to or less than the reference distance, the controller 120 controls the vehicle V to be steered with an increased steering angle compared to the initial avoidance steering angle α (S143).

Even when steering control is performed according to the initial avoidance steering angle α, if the turning radius R_{obj} of the target is still equal to or less than the reference distance, this indicates that steering control based on the initial avoidance steering angle α is not sufficient to avoid a collision with the target T. Accordingly, when it is additionally determined that the turning radius R_{obj} of the target is equal to or less than the reference distance, the controller 120 may control the vehicle V to be steered with an increased steering angle compared to the initial avoidance steering angle α.

Meanwhile, when it is additionally determined that the turning radius R_{obj} of the target exceeds the reference distance, the controller 120 controls the vehicle V to be steered with a reduced steering angle compared to the initial avoidance steering angle α (S144).

If, after steering control according to the initial avoidance steering angle α, the turning radius R_{obj} of the target is found to exceed the reference distance, this indicates that the steering control based on the initial avoidance steering angle α was sufficient to avoid a collision with the target T. Accordingly, when it is additionally determined that the turning radius R_{obj} of the target exceeds the reference distance, the controller 120 may control the vehicle V to be steered with a reduced steering angle compared to the initial avoidance steering angle α.

In this manner, after the controller 120 controls the vehicle V according to the initial avoidance steering angle α, the controller 120 additionally determines whether the turning radius R_{obj} of the target is equal to or less than the reference distance and adjusts the steering angle based on the additional determination result, thereby enabling a collision to be avoided by reflecting, in real time, a continuously changing position of the target T as the target T moves.

In an exemplary embodiment of the present disclosure, the step S140 of controlling the vehicle V to be steered according to an avoidance steering angle may be performed as described above.

Meanwhile, in step S130 of determining whether the turning radius R_{obj} of the target is equal to or less than the reference distance, when it is determined that the turning radius R_{obj} of the target exceeds the reference distance, the controller 120 controls the vehicle V to maintain an existing steering angle (S150).

For example, when the vehicle V has been moving forward or backward, the controller 120 may set a steering angle of the vehicle V to zero and perform steering control so that the vehicle V continues to move forward or backward.

The target T may move closer to or farther from the vehicle V while the vehicle V is driving. Accordingly, the controller 120 may periodically determine a position of a target T existing around the vehicle V based on detection information of at least one sensor 110 mounted to the vehicle V, and accordingly, the vehicle control method S100 may be performed periodically.

Also, the present disclosure provides a non-transitory computer-readable storage medium storing a program for performing the vehicle control method S100 according to an exemplary embodiment of the present disclosure. Specifically, the present disclosure may provide a non-transitory computer-readable storage medium on which a program including at least one instruction for performing the vehicle control method S100 is stored.

In this case, the instruction may include not only machine code generated by a compiler but also higher level language code executable by a computer. In addition, the storage medium may include a hardware device such as a magnetic medium such as a hard disk, a floppy disk and a magnetic tape; an optical medium such as a compact disk read only memory (CD-ROM) and a digital video disk (DVD); a magneto-optical medium such as a floptical disk; a read-only memory (ROM); a random access memory (RAM); a flash memory; and the like.

According to the above configuration, the vehicle control apparatus and method according to an aspect of the present disclosure effectively prevent a collision between a vehicle and an object around the vehicle during driving of the vehicle without driver intervention, based on a location of an object existing around the vehicle and a turning radius of the object determined according to a preset initial avoidance steering angle.

In addition, the vehicle control apparatus and method according to an aspect of the present disclosure effectively prevent a collision between a vehicle and an object around the vehicle even when the object is moving around the vehicle, by repeatedly determining the location of an object existing around the vehicle and a turning radius of the object determined according to a preset initial avoidance steering angle.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A vehicle control apparatus, comprising:

2. The vehicle control apparatus of claim 1,
wherein the controller is configured to determine the position of the target as coordinates on a two-dimensional plane in which a rear-wheel center of the vehicle, which is an intermediate point between a left rear wheel and a right rear wheel of the vehicle, serves as an origin, and axes parallel to a longitudinal direction of the vehicle and a lateral direction of the vehicle serve as two coordinate axes.

3. The vehicle control apparatus of claim 2,
wherein the controller is configured to determine the turning radius of the target according to Equation 1:
$${R}_{obj} = \sqrt{{( R + Y 1 )}^{2} + X {1}^{2}} \qquad ( Equation 1 )$$
(R_{obj}: turning radius of the target, R: turning radius of a rear-wheel center of the vehicle, X1: coordinate value among the coordinates that is parallel to a longitudinal direction of the vehicle, Y1: coordinate value among the coordinates that is parallel to a lateral direction of the vehicle)

4. The vehicle control apparatus of claim 3,
wherein a turning radius of a rear-wheel center of the vehicle according to the initial avoidance steering angle is determined as expressed in Equation 2:
$$R = \frac{B}{{tan}_{a}} \qquad ( Equation 2 )$$
(R: turning radius of a rear-wheel center of the vehicle, B: wheelbase of the vehicle, α:
the initial avoidance steering angle)

5. The vehicle control apparatus of claim 4,
wherein the reference distance is set as a sum of an outer turning radius of the vehicle and a margin distance.

6. The vehicle control apparatus of claim 5,
wherein an outer turning radius of the vehicle is determined as expressed in Equation 3:
$${R}_{car} = \sqrt{{( R + \frac{W}{2} )}^{2} + {( L - H )}^{2}} \qquad ( Equation 3 )$$
(R_{car}: outer turning radius of the vehicle, R: turning radius of a rear-wheel center of the vehicle, W: vehicle width, L: vehicle length, H: rear overhang of the vehicle)

7. The vehicle control apparatus of claim 1,
wherein the controller is configured to control the vehicle to be steered according to the initial avoidance steering angle when the turning radius of the target is equal to or less than the reference distance.

8. The vehicle control apparatus of claim 7,
wherein the controller is configured to, after controlling the vehicle according to the initial avoidance steering angle, additionally determine whether the turning radius of the target is equal to or less than the reference distance, and control the vehicle to be steered with an increased steering angle compared to the initial avoidance steering angle when the turning radius of the target is equal to or less than the reference distance.

9. The vehicle control apparatus of claim 7,
wherein the controller is configured to, after controlling the vehicle according to the initial avoidance steering angle, additionally determine whether the turning radius of the target is equal to or less than the reference distance, and control the vehicle to be steered with a reduced steering angle compared to the initial avoidance steering angle when the turning radius of the target exceeds the reference distance.

10. A vehicle control method, comprising:

11. The vehicle control method of claim 10,
wherein determining the position of the target comprises determining, by the controller, the position of the target as coordinates on a two-dimensional plane in which a rear-wheel center of the vehicle, which is an intermediate point between a left rear wheel and a right rear wheel of the vehicle, serves as an origin, and axes parallel to a longitudinal direction of the vehicle and a lateral direction of the vehicle serve as two coordinate axes.

12. The vehicle control method of claim 11,
wherein determining the turning radius of the target comprises determining, by the controller, the turning radius of the target according to Equation 1:
$${R}_{obj} = \sqrt{{( R + Y 1 )}^{2} + X {1}^{2}} \qquad ( Equation 1 )$$
(R_{obj}: turning radius of the target, R: turning radius of a rear-wheel center of the vehicle, X1: coordinate value among the coordinates that is parallel to a longitudinal direction of the vehicle, Y1: coordinate value among the coordinates that is parallel to a lateral direction of the vehicle)

13. The vehicle control method of claim 12,
wherein determining a turning radius of a rear-wheel center of the vehicle according to the initial avoidance steering angle comprises determining the turning radius of the rear-wheel center of the vehicle as expressed in Equation 2:
$$R = \frac{B}{{tan}_{a}} \qquad ( Equation 2 )$$
(R: turning radius of a rear-wheel center of the vehicle, B: wheelbase of the vehicle, α: the initial avoidance steering angle)

14. The vehicle control method of claim 13,
wherein the reference distance is set as a sum of an outer turning radius of the vehicle and a margin distance.

15. The vehicle control method of claim 14,
wherein determining the outer turning radius of the vehicle comprises determining the outer turning radius of the vehicle as expressed in Equation 3:
$${R}_{car} = \sqrt{{( R + \frac{W}{2} )}^{2} + {( L - H )}^{2}} \qquad ( Equation 3 )$$
(R_{car}: outer turning radius of the vehicle, R: turning radius of a rear-wheel center of the vehicle, W: vehicle width, L: vehicle length, H: rear overhang of the vehicle)

16. The vehicle control method of claim 10,
wherein controlling the vehicle to be steered according to the avoidance steering angle comprises controlling, by the controller, the vehicle to be steered according to the initial avoidance steering angle.

17. The vehicle control method of claim 16,
wherein controlling the vehicle to be steered according to the avoidance steering angle further comprises determining, by the controller, whether the turning radius of the target is equal to or less than the reference distance.

18. The vehicle control method of claim 17,
wherein controlling the vehicle to be steered according to the avoidance steering angle further comprises controlling, by the controller, the vehicle to be steered with an increased steering angle relative to the initial avoidance steering angle when the turning radius of the target is equal to or less than the reference distance.

19. The vehicle control method of claim 18,
wherein controlling the vehicle to be steered according to the avoidance steering angle further comprises controlling, by the controller, the vehicle to be steered with a decreased steering angle relative to the initial avoidance steering angle when the turning radius of the target exceeds the reference distance.

20. A non-transitory computer-readable storage medium storing a program comprising at least one instruction for performing a vehicle control method,
for avoiding the target when the turning radius of the target is equal to or less than the reference distance.
